(19) United States
(12) Patent Application Publication
(10) Pub. No.: US 2026/0216859 A1
(43) Pub. Date: Jul. 30, 2026

(54) COMPACTABLE POWERED GRASPING DEVICE

(71) Applicants: Sidney MOORE, Maumelle, AR (US); Daniel EVANS, Rowlett, TX (US)

(72) Inventors: Sidney MOORE, Maumelle, AR (US); Daniel EVANS, Rowlett, TX (US)

(21) Appl. No.: 19/147,231

(22) PCT Filed: Jan. 16, 2023
(86) PCT No.: PCT/US2023/010864

§ 371 Date: Jul. 10, 2025

(51) Int. Cl. B25J 1/02; B25J 9/16; B25J 18/02

(52) U.S. Cl. CPC B25J 1/02; B25J 9/1633; B25J 18/025

(57) ABSTRACT

A reach assistive grabbing or grasping device for retrieving remote objects, comprised of a telescopically contractable arm terminating at one end with a gripping mechanism that is electrically manipulated to open from a default closed position. The contractable arm defaulting to a retracted compacted configuration that is manually or electrically extendable. The powered operation and default configuration eliminating the need for constant pressure during retrieval of an object and simplifying operation by users having limited muscular exertion and/or impaired motor control skills.

### BACKGROUND OF THE INVENTION

### Cross-Reference to Related Applications

Not Applicable.

### STATEMENT REGARDING FEDERALLY SPONSORED RESEARCH OR DEVELOPMENT

### Not Applicable.

Reference to Sequence Listing, a Table, or a Computer Program Listing Compact Disc Appendix Not Applicable.

### Technical Field of Innovation

The present innovation is directed to an assistive device for reaching and grasping of remote objects. Specifically, it is a grabbing or grasping reach extension device that is compactable, powered, and adaptable for convenient carrying and ease of accessibility by persons using walkers, wheelchairs, crutches, or canes particularly persons having impaired dexterity and/or diminished fine muscle control.

### BACKGROUND ART

Gripping tools have existed for years for the convenience of those who may have occasion to retrieve articles from the floor or ground, especially where repetitive action is needed, such as picking up litter. Occasion also exists to retrieve articles from high places normally out of reach. For example, a gripping tool may be stored near high shelves for infrequent, but foreseeably expected future need.

But persons with disabilities may requires gripping tools regularly throughout a typical day. Grocery shopping from a wheelchair or retrieving dropped objects while requiring the use of crutches makes access to a gripping device a necessity for many poople. Typical gripping devices are usually 3 or more feet in length and comprised of hooks, magnets, and/or grippers at one end with distal handles, triggers, etc. making their transport less than convenient.

Some devices include a foldable joint or have sectional additions, but such configurations can take effort to deploy since changes in their length usually require manual adjustment of inner tensioning elements that control grasping operations. Changing lengths may also require more than single handed operation or demand higher strength/greater dexterity than a disabled user is capable of supplying when demanded by use of the device.

Shorter devices are of limited use for reaching task. Longer devices are cumbersome to transport. Having to retrieve a reach device anytime there is needed may be task interrupting. But not having a reaching device available for retrieval can be life interrupting. This is something the disabled experience regularly.

Someone in a wheelchair or mobility scooter often require reach assistance for items typically considered to be conveniently placed. For example, upper level shelves in grocery stores. Not having the ability to stand up and grab a box off a high shelf can be frustrating. Having to constantly ask for help from others may be embarrassing. But fumbling with long assistive reach devices or constantly unfolding and folding compact devices may not be any better.

### SUMMARY OF THE INVENTION

The present invention is an assistive device for reaching and grasping remote objects, comprised of a telescopically contractable/compactable arm facilitating convenient stowage for transport while remaining readily at hand. The device has a grasping mechanism that is electrically manipulated to eliminate complex folding and cable tensioning required of manually operated devices.

The device defaults to a closed position eliminating the need for constant pressure during retrieval of an object. Additionally, the compactable arm defaults to a closed position that is electrically extendable to further assist in operation by the impaired.

### BRIEF DESCRIPTION OF THE DRAWINGS

FIG. 1 shows currently available reach assistive devices.

FIG. 2 illustrates a manually compactable powered grasping device in accordance with an exemplary embodiment of the invention.

FIG. 3 shows the same manually compactable device from FIG. 2 in demonstrating an extended configuration in accordance with an exemplary embodiment of the invention.

FIG. 4 shows a power extendable configuration of a compactable powered grasping device and illustrates exemplary controls thereon for powered manipulation in accordance with an exemplary embodiment of the invention.

FIG. 5A shows a cross section view of a power extendable embodiment of a compactable powered grasping device showing an exemplary embodiment of wiring and component configuration for controlling the arm under power control in accordance with the invention herein.

FIG. 5B shows a cross section view of the same powered extendable embodiment of a compactable powered grasping device showing exemplary displacement of components during a powered extension operation in accordance with the teachings of the inventor herein.

FIGS. 6A & 6B are illustrative of an alternative non-coaxial configuration of a compactable powered grasping device in accordance with an exemplary embodiment of the inventor teachings.

### DETAILS OF THE INVENTION AND THE PREFERRED EMBODIMENT

The innovation has a powered grasping/grabbing/gripping mechanism at one end of a linearly telescoping compactable arm. The grasping mechanism has one or more positional fingers, movable between open and closed positions for the grabber to release or grip an object. In one embodiment two or more fingers may be adjoined at one end in a palm-like region, i.e., a virtual palm.

In another embodiment, the grabber may have two or more fingers oriented around the perimeter of a central hand element, i.e., a palm. In either embodiment one or more illuminating elements, e.g., LEDs, incandescent bulbs, cameras, sensors, etc. may be integrated into the palm or fingers and oriented to aid positioning the grabber relative to a target object. The illumination may be individually controllable or may be configured to activate anytime the grabber is out of the default configuration, i.e., when a user is actively trying to grasp an object.

The compacting operation of the device may be manipulated manually or electrically. The terms grab/grip/grasp and variations thereof are considered generally equivalent, are used interchangeably here in unless specifically indicated by context. The powered grabbing/grasping/gripping operation specifically references manipulations and/or orientation of the palm and/or fingers.

The manipulation of the pivoting wrist joint may be comprised of an angular displacement and/or a rotational orientation, either or both of which may be powered or manual operations in different embodiments, all of which are applicable unless otherwise dictated by context.

The fingers curve inwardly and are operated by electromechanical controls opening to release or closing to curl around a targeted object or otherwise grip some portion thereof. In either embodiment, the fingers may curve or curl toward the central palm area or otherwise be coordinated in alignment to encircle, pinch, or otherwise grip a target object. The preferred embodiment biases the fingers toward the closed position to grip by default.

The reach device's grabber may be pivotally connected at one end of the linear arm of adjustable length, to form a type of wrist joint. The grabber state is transitioned between released and gripped through manipulated finger positions controlled by a controller handle forming the arm's distal end. The arm's length varying by extending or contracting a plurality of telescoping tubes.

The reach assistance device may have multiple configurations requiring different control arrangements or controller configurations. In one instance the device may be carried in an extended configuration, and only contracted occasionally for assorted reasons.

In another instance the device defaults to a compact configuration (contracted telescoping tubes) where the arm would need to be extended each time the device is used for reaching. Depending on the embodiment, the extending arm may be manually or electrically operated.

In a manually extended embodiment, a user may extend or contract the expanding arm to any distance. Electrical control of the grabber can transition between release or grip states of the grabber. In one embodiment, one or more of the grabber's fingers may be biased, for instance by springs, toward a default position. Electrical control is used to force a change from the default position to an alternative state, and removal of that force returns the grabber to the default state.

In an alternative embodiment, the grabber may include an illumination device, such as an LED which is switchable, or automatically activated when the grabber position is not in the default position. In an electrically extended embodiment, the controller handles' grabber positioning controls are augmented with arm positioning controls.

Positioning controls in one embodiment may have separate open and close switches. Another embodiment may employ a directional switch and an activation switch where activation changes position in relation to a selected direction. For example, a directional switch may select a positive or negative position change upon activation of a trigger controlling a linear actuator.

In the preferred embodiment, a positioning control operates through a bi-directional lever switch spring biased to a neutral center position. The control is activated by moving the lever from the center and alters positioning relative to direction of displacement.

Such a lever switch may be oriented as a trigger on the handle and have a finger loop for bi-directional manipulation. Optionally, such a control may use displacement distance to proportionally vary speed and/or force of the electromechanical operation being controlled.

A manually extended embodiment may need only a single positioning control for operation of the grabber. In an alternative embodiment, a manually extended embodiment may also include an additional positioning control for rotational orientation of the grabber.

In an alternative embodiment, a single positioning control may be supplemented by a secondary switch for selectively positioning the grabber's orientation (i.e., rotate a wrist joint clockwise or counterclockwise) or altering the grabber's expansion state (i.e., transition fingers between open and closed extremes).

An electromechanically extended embodiment may include separate positional controls for the grabber's expansion, orientation, and the arm's elongation, (i.e., transition between extended/contracted states). In an alternative embodiment, a single positioning control may be supplemented by a secondary switch for selectively determining the positioning operation to be manipulated by the positioning control.

In alternative embodiments, the positioning control(s) or other physical components may incorporate sensors to identify extent limits of operations and alert or prevent actions beyond physical limits or other potentially damaging operation.

In an alternative embodiment the electromechanically controlled arm length and the grabber's expansion operations may be linked to offer further assistive capabilities for users having particular disabilities, including but not limited to a decrease in fine motor control skills or difficulty with extended muscular exertion.

Such an embodiment may use limit sensing to configure/control operation of the device such that extending the arm to the extension limit then causes grabber expansion. Closing of the grabber to the closing limit could then causes contraction of the arm. In this arrangement, a single control operation may start arm extension followed by expanding of the grabber.

After which a single control operation may close the grabber followed by contracting of the arm. This would allow a user to concentrate only on positioning of the grabber relative to a desired object making its retrieval less demanding on an impaired user.

In another embodiment, a single switch may be the only necessary control. Activation of the control causing the arm to extend to the extension limit, the grabber to release, and illumination of the target object.

Once the user positions the grabber to grip the desired target, releasing the control, would cause the light to turn off, the gabber to default to a grip state, and the arm to contract. In another embodiment, the activation and releasing of the control may be two distinct switch activations. For example, pressing a button two separate times, once to extend/open and once to close/retract.

By defaulting to a compact configuration, the reach assistance device may be secured by a strap, placed in a pocket or holster type holder on a cane, a walker, or wheelchair without swaying, swinging, or dangling loosely where it may interfere with wheel spokes, contact the user or a passing person, catch on a door jamb, or otherwise further impede mobility.

This is particularly important for those already experiencing impeded mobility issues. The compact configuration may be desirable for use with a wheelchair, electric scooter, or in a stationary chair because the compact configuration allows the device to be placed in a basket, on a nearby surface, or beside the user on a seat.

While the compact configuration eases transportation concerns, it should not hinder usability. The preferred embodiment of the reach assistance device is a powered device extendable under minimal user control effort and having a powered grabber that defaults to a closed state so continuous activation efforts are not required to retrieve an object.

The electromechanical configuration of the extendable arm of the reach assistance device is comprised of a plurality of nesting tubes linearly telescoping to form a linear bar assembly, a bar. The preferred embodiment comprises two coaxial bars forming a double wall configuration, each wall being distinguished as an internal rotating bar (the rotating bar) and an external sliding bar (the sliding bar). Esthetics and other design preferences dictated the internal and external placement of the two variations but does not preclude alternative placement.

The sliding bar is comprised of nesting tubes having a polygonal cross section. The preferred embodiment being hexagon. A polygonal tube means the corners and sides prevent rotational displacement of the nested tubes, which remain freely slidable along their common axis, their relational displacement varying the bar length.

The rotating bar is comprised of nesting tubes threaded on the inside or outside surface for substantially the entire length. The other surface is threaded at one end for at least a portion of the length. The spiraling threaded surfaces of adjacent nested tubes rotationally interact to cause linear displacement along the common axis varying their combined length. Reversing the rotational movement reverses the tubes variation in length.

The tubes have mechanical limits on at least one end comprised of end stops which limiting displacement and interact to provide strength supporting the arm when extended. Displacement of the nested polygonal tubes is controlled by joining to the rotating bar at each end, such that the two bars are substantially equal. Therefore, extension or contraction of the rotating bar causes rotation or extension of the sliding bar.

The preferred embodiment orients a first bar and a second bar in a coaxial orientation with distal extremes of the two variations of the bars affixed to simultaneously vary length of the extendable arm while providing rotational stability. In alternative embodiments multiples of one or more of the variations may be arranged in an axially distinct orientation to vary length of the extendable arm while remaining rotationally stable.

For example, a variation (rotating threated) tubes may be flanked by two of the other variation (sliding polygon) tubes, all three joined at distal extremes. The preferred embodiment's ‘double wall’ configuration of the tube variations coaxial orientation is believed to provide additional strength and to allow additional bracing between the walls.

In the preferred embodiment a motor provides rotational force to the rotating bar. Electrical traces are, conducting paths oriented within one of the bars to provide power and control signals from the controller located in the handle and the grabber and/or wrist. The traces of the preferred embodiment are traces on a carrier board affixed to the interior wall of each sliding tube, joined at one end to flexible wires extending back and connecting to the distal end of an adjacent carrier board.

The extreme ends of the traces at one end connect to the controller circuitry, and at the distal end connect to electromechanical components of the grabber, wrist, and/or illuminating elements. Electrical power may be tethered, or batteries. A rechargeable battery embodiment may also be supplemented with charging circuitry to enhance usability and mobility.

To discourage interference, the carrier boards of each tube may be angularly displaced to adjacent interior walls of the polygon tubes from that of the adjacent tube. In an alternative configuration, the carrier boards of each polygon tube may be oriented on the same wall, such as the upper wall, but shifted side to side to prevent entanglement of the flexible traces connected thereto.

### DETAILED DESCRIPTION OF THE DRAWINGS

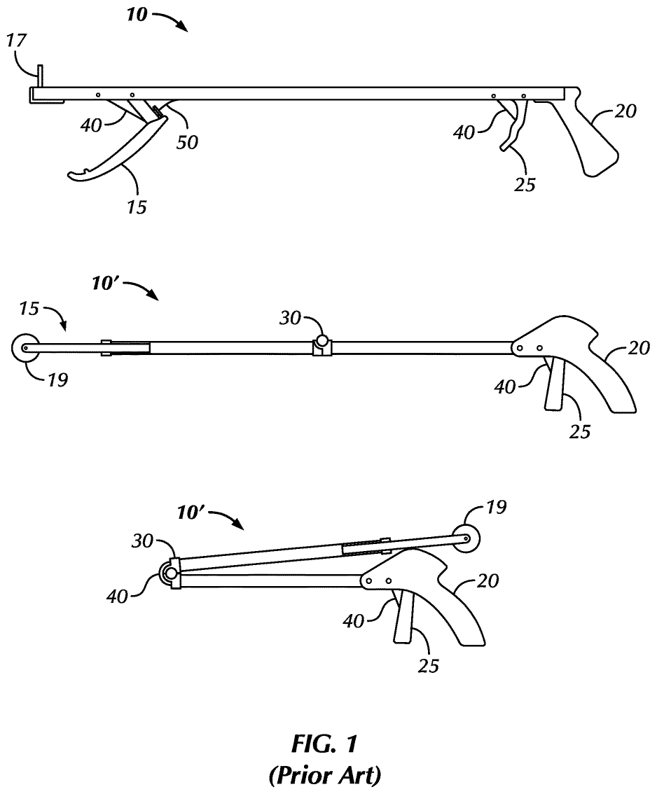

FIG. 1 shows currently available reach assistive devices. The illustrations are exemplary of current technology. The bottom gripping device (10) has a gripping component at one end for retrieval or manipulation of distant objects. The top illustrations show a foldable gripping device (10′) compactable by a foldable joint (30) located between the pinchers (15) and the handle (20).

The bottom gripping device (10) can be used to interact with a target object through a hook and/or magnet (17) or a pincher (15). The pincher is biased open, i.e., pulled to an open position by a spring or elastic cord (50). The biasing can be overpowered by a force closing the pincher to grip a desired target. But the force must be maintained as long as the object is to be gripped and slacking or reducing the force can cause the object to slip or be dropped.

The operating force is applied by a tensioning/operation cord (40) applying force/pulling force is controlled from the handle (20) at the device's distal end. The cord (40) extends through the length of the device and connects to a trigger (25) found at or as part of the handle (20).

The foldable gripping device (10′) illustrated use a pair of pinchers (15) with suction cups (19) to assist in gripping an object when the force from the biasing spring (50, not visible) is overcome by a closing force applied by the tensioning/operation cord (40) applying force controlled from the handle (20) at the device's distal end. The cord (40) extends through the length of the device, passing through the foldable joint (30), to connect to the trigger (25) located or found at the handle (20).

While not seen in the viewing angle of the illustration, one skilled in the art is familiar with the limitations prevalent in such a configuration. That the change in tension of the cord (40) necessary for bridging the folded parts of the foldable joint (30) limits the device's useable configurations.

This tensioning change means the foldable gripping device (10′) is only operatable in a fully extended state since changes in the tension result in closure of the gripping device and cause a strain/weakening of the biasing components and expose the cord to wear/abrasion which shorten the useful operating life of a device.

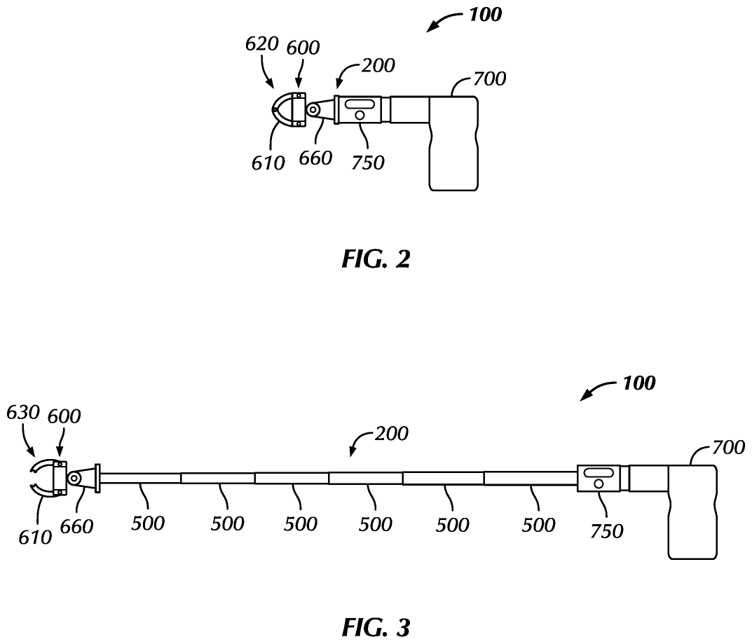

FIG. 2 illustrates a manually compactable configuration of a compactable powered grasping device in accordance with an exemplary embodiment of the invention. The manually compactable powered grasping device (100) is a reach assistance device for grabbing and/or manipulating distant objects.

The device (100) comprises an adjustable length linear arm, an arm (200) connected at one end to a handle assembly (700). The device (100) further comprises an electromechanical gripper (600) connected to the distal end of the arm (200).

One or more electronically positional fingers (610) either directly connect together, or join to a palm (640, not designated in this figure) to form the electromechanical gripper (600). The gripper (600) may connect directly to the arm (200) or could optionally include a pivoting wrist joint (660), which may be mechanically or electromechanically positionable, to provide the device with more degrees of freedom.

The electromechanical positioning of the wrist joint (660) and fingers (610) of the electromechanical gripper (600) are electronically controlled by a gripper activating controller (750) comprising part of the handle assembly (700) at the distal end of the adjustable length linear arm (200).

In one embodiment, the control movements may be conveyed by a plurality of electrical conducting traces or wires. In another embodiment, the control movements may be wirelessly transmitted between the controller (750) and the gripper (600).

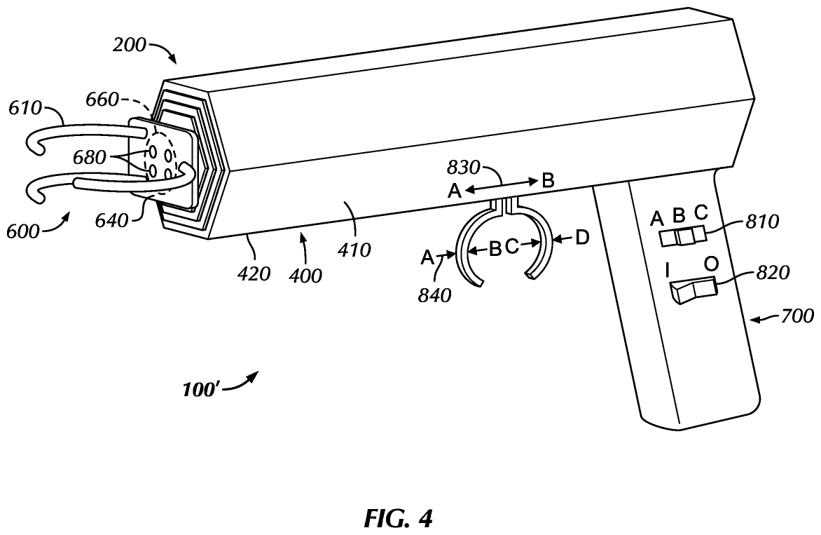

FIG. 3 shows the same manually compactable device from FIG. 2 in demonstrating an extended configuration in accordance with an exemplary embodiment of the invention. The manually compactable powered grasping device's (100) linear arm (200) is comprised of one or more linear bar(s) (collectively 210).

In this embodiment, the linear arm (200) is a single linear bar (210) comprised of a plurality of coaxial nesting tubes (500) which are telescopically positional and may be manually adjusted. The slidable and rotatable telescoping tubes (500, see FIG. 3) are limited by end flares, end compressions in manners commonly known by those skilled in the arts to prevent disengagements during linear displacements from neighboring tubes during sliding movements in a linear direction. The tubes (500) are free to rotate relative to one another about their common axis.

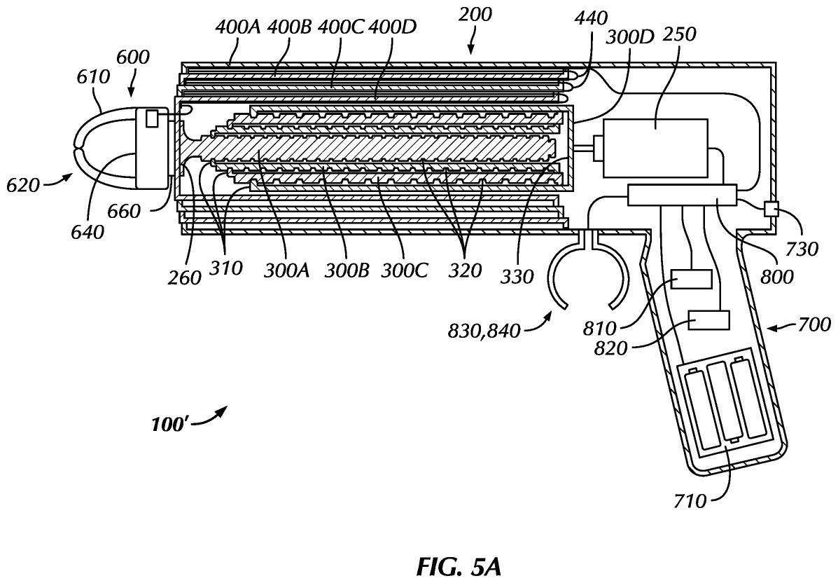

FIG. 4 shows a power extendable configuration of a compactable powered grasping device and illustrates exemplary controls thereon for powered manipulation in accordance with an exemplary embodiment of the invention. In this configuration of a power compactable powered grasping device (100′), the arm's (200) length adjustment, and the operations of the gripper (600) require multiple controls (810-840) for rotation of the palm (640) by the wrist joint (660), positioning of the fingers (610), and controlling illumination elements (680).

The trigger may operate as a single element (830) for moving between two positions (830A, 830B). Alternately, the trigger(s) may operate independently (840) with each trigger moving between two positions (840A, 840B) and (840C, 840D).

In addition or in the alternative, the controls may comprise one or more switches (810, 820) having multiple electromechanical selections (810A, 810B, 810C) for specifying a specific electromechanical device, and operation of that device as on/off or positive/negative (820I, 820O).

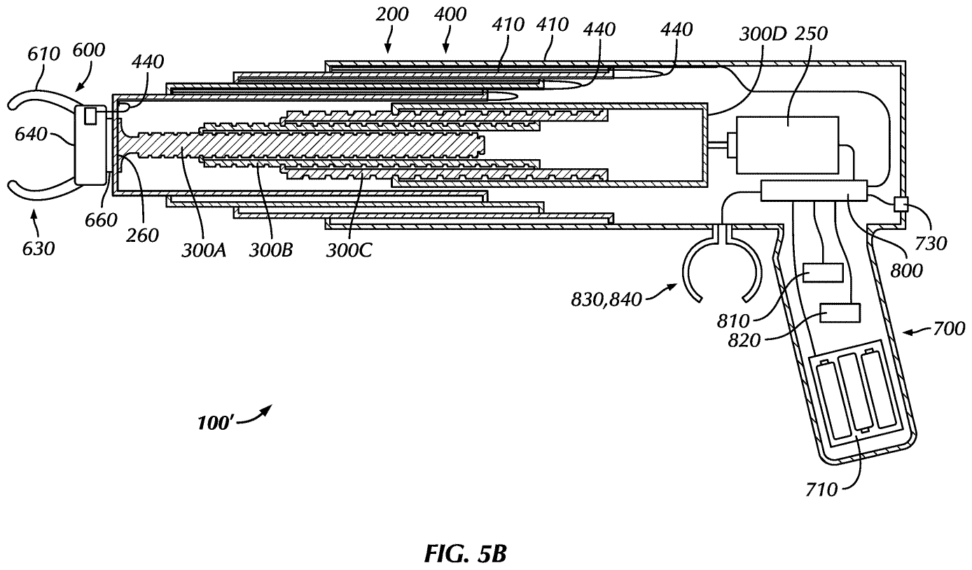

The multiple controls (810-840) are located at the handle assembly (700) end of the linear arm (200). The linear arm (200) is comprised of two linear bars (collectively 210, not indicated), that are coaxially aligned (400, external visible; and 300, internal hidden). Each linear bar (210) as previously stated, is a plurality of nesting telescopic tubes (300 see FIGS. 5A & 5B) (400 see FIG. 4, FIGS. 5A & 5B) and (500 see FIG. 3).

The telescopic tubes (400) of the visible linear bar (210) have a polygon cross section, here a hexagon. The polygon has sides (410), and angles/corners (420) which allow linearly slidable displacement, but prevent rotational displacement, as further shown in the later figures.

FIG. 5A shows a cross section view of a power extendable embodiment of a compactable powered grasping device showing an exemplary embodiment of wiring and component configuration for controlling the arm under power control in accordance with the invention herein. In this configuration of a power compactable powered grasping device (100′), the arm's (200) length is illustrated in the preferred default compacted position, i.e., with the arm (200) retracted.

The handle assembly (700) comprises controller (800) configured to respond to the one or more controls (810-840) to operate the device (100′). The controller (800) has a power supply (710), herein shown as batteries (720, not labeled) which may be rechargeable through recharging circuitry (730) and/or charge level monitoring circuitry (740) incorporated in the controller (800).

The controller (800) adjusts the length of the linear arm (200) by adjusting the length of the two linear bars (210, not labeled), which are coaxially aligned (400 & 300). Each linear bar (210) as previously stated, is a plurality of nesting telescopic tubes (300A-300D & 400A-400D), which are uniquely configured to control linear displacement of the arm (200).

The telescopic tubes (400) of this embodiment's outer linear bar (210) have a polygon cross section, here a hexagon. The polygon has a plurality of sides (410), and angles/corners (420) which allow linearly slidable displacement but prevent rotational displacement.

The telescopic tubes (300) of this embodiment's inner linear bar (210) have a round cross section, i.e., they are generally cylindrical in shape (300A-300 D). Treading on the length of one axial surface is configured to interact with threading on the distal surface of an adjoining tube. The threading on one of the axial surfaces extends substantially the length of the tube (320). The threading on the distal axial surface may partially extend from one end (310).

The controller (800) adjusts the length of the linear arm (200) by rotating a motor (250) connected to the fixed end stop (330) of one extreme end of the rotational linear bar (300D). Rotation of the motor causes a linear displacement as the threading (310) of one tube (300) interacts with the threading (320) of its neighbor. The distal extreme end of the rotational linear bar (300) is adjoined (260) to the extreme end of a tube of the slidable linear bar (400).

The joint (260) between the gripper end of the linear bars (300, 400) syncs their linear displacement producing a dual wall construction of the linear arm (200) providing support when the arm (200) is extended, which may be further enhanced by further limiting linear displacement of the telescopic joints.

The controller (800) operates the gripper (600) through electrical signals conducted by conductors (410 & 440) passing through the arm (200). The preferred embodiment uses carrier planes (410) affixed to the internal surface of the slidable linear bar (210, 400). The carrier planes (410) are joined end to end by flexible conductors (440), which interact to prevent the electrical conductors (410 & 440) from entangling within the device (100′).

The powered gripper (600) is shown with the palm (640), pivoting wrist joint (660) and positional fingers (610) oriented in the preferred default closed (620) or gripping position. The controller operates the gripper (600) through electrical signals conducted by flexible conductors (440) passing through the arm (200).

The preferred operation is to first, force the gripper (600) from the default closed position (620), i.e., to an open configuration (630, see FIG. 5B), and activate illuminating elements (680, not visible). Then to rotate the motor (250) causing extension of the adjustable length of the linear arm (200).

FIG. 5B shows a cross section view of the same powered extendable embodiment of a compactable powered grasping device showing exemplary displacement of components during a powered extension operation in accordance with the teachings of the inventor herein. In this configuration of a power compactable powered grasping device (100′), the arm's (200) length is illustrated in a partially extended position with the powered gripper (600) shown in one of multiple opened positions (630), i.e., not in the default closed (620) or gripping position.

In a continued description of the preferred operation, once the gripper (600) is positioned relative to the target object, on user command, or after a specified delay, the force on the gripper (600) is released or reversed, allowing the biasing (650) to return the palm (640) and fingers (610) toward the default closed position (620), gripping the object, after which the controller reverses rotation of the motor (250) to retract the linear arm (200) to the default contracted configuration.

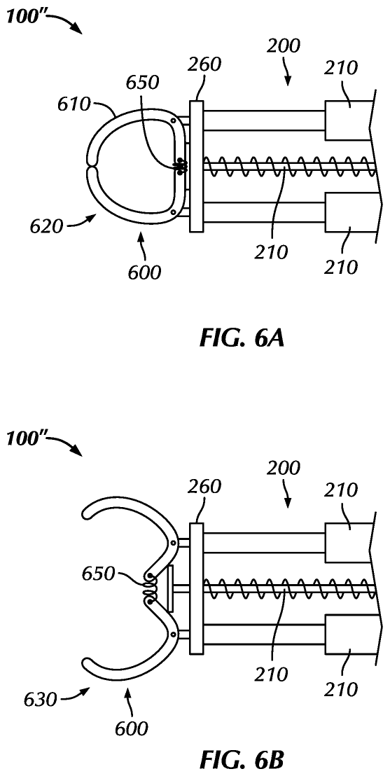

FIGS. 6A & 6B are illustrative of an alternative non-coaxial configuration of a compactable powered grasping device in accordance with an exemplary embodiment of the inventor teachings. In this configuration of a non-coaxial compactable powered grasping device (100″), the arm (200) is comprised of a plurality of linear bars (210) joined at the gripper (600) end, i.e., distal end from the handle assembly (700, not visible).

The powered gripper (600) is shown with positional fingers (610) biased by a spring (650) extending there between. FIG. 6A shows the gripper (600) in the preferred default closed (620) or gripping position. FIG. 6B shows the gripper (600) being forced by one of the linear bars (210) to an open configuration (630).

Figures in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated.

Some elements illustrated in the singularity may actually be implemented in a plurality. Additionally, some element illustrated in the plurality could actually vary in count. Elements illustrated in one form could actually vary in detail. Specific information should be interpreted as illustrative for discussing exemplary embodiments and is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A reach assistance device comprising:
an adjustable length arm;
an electrical grabber attached to one end of the arm, the grabber comprising:
one or more electromechanically positionable fingers; and
a handle attached to the arm's distal end, the handle further comprising:
a power supply, and
a controller configured to manipulate finger position to transition the grabber between a closed, grip state and release states.

2. The reach assistance device, as described in claim 1 wherein the grabber is biased toward the grip state.

3. The reach assistance device, as described in claim 2 wherein:
one or more springs bias the fingers toward a close position.

4. The reach assistance device, as described in claim 2 wherein the grabber further comprises an illumination element.

5. The reach assistance device, as described in claim 4 wherein the illumination element is active when the grabber is in a release state.

6. The reach assistance device, as described in claim 1 wherein:
the power supply comprises a battery.

7. The reach assistance device, as described in claim 6 wherein:
the battery is rechargeable, and
the power supply further comprises battery charging circuitry.

8. The reach assistance device, as described in claim 7 wherein the power supply further comprises battery charge level monitoring circuitry.

9. The reach assistance device, as described in claim 1 wherein the arm comprises a plurality of slideably nesting coaxial tubes forming a telescoping linear bar.

10. The reach assistance device, as described in claim 9 wherein the arm further comprises two or more linear bars wherein:
the linear bars are aligned parallel to each other, and
are linked at extreme distal ends to substantially limit relative movement therebetween varying arm length.

11. The reach assistance device, as described in claim 10 wherein two bars comprise:
a first support wall, and
a second support wall;
wherein the support walls are co-axially oriented.

12. The reach assistance device, as described in claim 11 wherein one of the support walls further comprise:
the tubes having threading of at least a portion their inner and outer surfaces,
the threads of adjacent tube surfaces interconnected such that relative rotation between adjacent tubes causes linear displacement, and
threaded surfaces further comprising mechanical limitations to maintain axial support therebetween.

13. The reach assistance device, as described in claim 11 wherein one of the support walls further comprises:
the tubes having a polygon shaped cross-section,
the sides and corners of the polygon tubes preventing rotation and limiting relative movement between adjacent tubes to linear displacement, and
the tube ends further comprising mechanically limits to linear displacement maintain axial support therebetween.

14. The reach assistance device, as described in claim 13 wherein the polygon tubes further comprise:
a plurality of electrically conductive traces interconnected between adjacent tubes and electrically conductive between distal ends of the support wall.

15. The reach assistance device, as described in claim 14 wherein the traces comprise:
a plurality of linear segments corresponding to each tube, wherein the distal end of each linear segment comprises electrical connectors for adjoining adjacent segments or electrical components.

16. The reach assistance device, as described in claim 15 wherein a linear segment comprises:
a first part substantially affixed to the interior surface of a tube; and
a flexible second part joined to one end of the first part,
oriented back toward the distal end of the first part,
adjoined to an adjacent segment or electrical component, and
flexing upon linear displacement of nested adjacent segments.

17. The reach assistance device, as described in claim 16 wherein the linear segment further comprises an angular displacement between affixed parts of linear segments in adjacent tubes.

18. The reach assistance device, as described in claim 1 wherein the controller is further configured to vary speed in electromechanical manipulations proportional to a controlling sensor.

19. The reach assistance device, as described in claim 1 wherein the controller is further configured to vary force in electromechanical manipulations proportional to a controlling sensor.

20. The reach assistance device, as described in claim 5 wherein:
the controller is configured to activate, wherein activate comprises:
extending the arm,
opening the finger positions to release the grabber, and
activating the illuminating element; and
the controller is configured to deactivate, wherein deactivate comprises:
gripping the grabber,
deactivating the illuminating element, and
contracting the arm.
